(19) United States
(12) Patent Application Publication
(10) Pub. No.: US 2026/0252597 A1
(43) Pub. Date: Aug. 27, 2026

(54) RETRIEVAL-AUGMENTED QUESTION ANSWERING

(71) Applicant: ADOBE INC., SAN JOSE, CA (US)

(72) Inventors: Yeonjun In, Suwon-si (KR); Sungchul Kim, San Jose, CA (US); Ryan A. Rossi, San Jose, CA (US); Md Mehrab Tanjim, Santa Clara, CA (US); Tong Yu, Fremont, CA (US); Ritwik Sinha, Cupertino, CA (US)

(21) Appl. No.: 19/062,235

(22) Filed: Feb. 25, 2025

(51) Int. Cl. G06F 16/3329; G06F 16/93; G06N 3/0455

(52) U.S. Cl. CPC G06F 16/33295; G06F 16/93; G06N 3/0455

(57) ABSTRACT

A method, apparatus, non-transitory computer readable medium, and system for data processing includes obtaining a query relating to a set of documents, generating a plurality of first interpretations of the query, retrieving a plurality of text passages from the set of documents based on the plurality of first interpretations, and generating a response to the query based on the plurality of text passages.

### BACKGROUND

Language models, such as large language models (LLMs), are machine learning models that are trained to output text based on an input, such as a text query. Language models store information in parametric memory that can be used to perform natural language processing tasks, such as question answering.

Existing data processing systems may also use a retrieval-augmented generation (RAG) process to answer questions by retrieving information corresponding to a question and using a language model to generate an answer to the question based on the retrieved information. However, a question may be ambiguous, or capable of being interpreted in multiple different ways. Existing data processing systems do not retrieve information that corresponds to multiple interpretations of a query, or inefficiently perform multiple rounds of information retrieval.

### SUMMARY

Systems and methods are described for performing efficient and accurate retrieval-augmented generation of a response to a query. In one example, a data processing system generates a set of interpretations of a query using a language generation model, and retrieves a set of text passages that encompasses the set of interpretations from a database. The data processing system uses the language generation model to generate a response to the query based on the set of text passages.

By generating the set of interpretations of the user query, the language generation model accounts for multiple potential meanings of the query. Because the set of text passages are retrieved based on the set of interpretations, rather than on the query itself, the data processing system obtains context that includes answers for each of the potential meanings of the query.

Therefore, because the response is generated based on the retrieved set of text passages, the response is more likely to include an answer to the query that accounts for an intended meaning of the query, and is therefore more accurate than responses provided by existing data processing systems and methods that employ a RAG process. Furthermore, the data processing system avoids a step of retrieving additional contextual information used by an iterative RAG approach, and is therefore more efficient than the iterative RAG approach.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 shows an example of a data processing system for retrieval-augmented question answering according to aspects of the present disclosure.

FIG. 2 shows an example of a method for retrieval-augmented question answering for ambiguous questions according to aspects of the present disclosure.

FIG. 3 shows an example of a data processing system for generating a set of first interpretations according to aspects of the present disclosure.

FIG. 4 shows an example of a first prompt according to aspects of the present disclosure.

FIG. 5 shows an example of a second prompt according to aspects of the present disclosure.

FIG. 6 shows an example of a data processing system for retrieving relevant and diverse passages according to aspects of the present disclosure.

FIG. 7 shows an example of a data processing system for retrieval verification according to aspects of the present disclosure.

FIG. 8 shows an example of a data processing system for response generation according to aspects of the present disclosure.

FIG. 9 shows an example of a transformer according to aspects of the present disclosure.

FIG. 10 shows an example of a method for generating a response to a query based on a set of retrieved text passages according to aspects of the present disclosure.

FIG. 11 shows an example of a method for generating a set of first interpretations based on prompts according to aspects of the present disclosure.

FIG. 12 shows an example of a method for retrieving a set of text passages according to aspects of the present disclosure.

FIG. 13 shows an example of an algorithm for generating a response to a query according to aspects of the present disclosure.

FIG. 14 shows an example of a method for generating a response based on first and second interpretations of a query according to aspects of the present disclosure.

FIG. 15 shows an example of a computing device according to aspects of the present disclosure.

FIG. 16 shows an example of a data processing apparatus according to aspects of the present disclosure.

### DETAILED DESCRIPTION

### Overview

Language models, such as large language models (LLMs), are machine learning models that are trained to output text based on an input, such as a text query. Language models store information in parametric memory that can be used to perform natural language processing tasks, such as question answering. Existing data processing systems may also use a retrieval-augmented generation (RAG) process to answer questions by retrieving information corresponding to a question and using a language model to generate an answer to the question based on the retrieved information.

Some existing RAG systems use a single retrieval process in which information that corresponds to a question is retrieved, and an answer is generated based on the retrieved information. However, a question may be ambiguous, or capable of being interpreted in multiple different ways, and the single retrieval process is insufficient to retrieve information that encompass all plausible interpretations of the query, leading to significant performance degradation in terms of factual accuracy.

Other existing systems use an iterative RAG approach in which information is retrieved based on a question, an initial answer is generated based on the retrieved information, additional information is retrieved based on the initial answer, and a final answer is generated based on the additional information. However, the iterative RAG approach is inefficient because of a significant increase in computational overheads due to iterative information retrieval and LLM reasoning, which also increases inference time and API call costs.

Accordingly, systems and methods are described for performing efficient and accurate retrieval-augmented generation of a response to a query. In one example, a data processing system generates a set of interpretations of a query using a language generation model, and retrieves a set of text passages that encompasses the set of interpretations from a database. The data processing system uses the language generation model to generate a response to the query based on the set of text passages.

By generating the set of interpretations of the user query, the language generation model accounts for multiple potential meanings of the query. Because the set of text passages are retrieved based on the set of interpretations, rather than on the query itself, the data processing system obtains context that includes answers for the potential meanings of the query.

Therefore, because the response is generated based on the retrieved set of text passages, the response is more likely to include an answer to the query that accounts for an intended meaning of the query, and is therefore more accurate than responses provided by existing RAG systems and methods. Furthermore, the data processing system avoids a step of retrieving additional contextual information used by the iterative RAG approach, and is therefore more efficient than the iterative RAG approach.

Additionally, in some embodiments, the data processing system determines that the set of text passages encompasses at least a portion of the set of interpretations of the query, and generates the response based on the determination. The data processing system therefore verifies an overall quality of the retrieved set of text passages before indiscriminately using the set of text passages in the response generation process, which further increases an accuracy of the response.

### Terminology Examples

A “query” is a text string that includes a question. The query relates to a set of documents. A “document” is a piece of written, printed, or electronic matter that includes information. Examples of a document include a word processing document file, a text document file, a Portable Document Format (PDF) file, a web page, a spreadsheet file, a presentation slide file, a smartphone or tablet app, etc. In some embodiments, a query relates to a set of documents by including a question that is answerable at least in part on the basis of information included in the set of documents. A “text passage” refers to an extract of text included in a document. A “response” is a text output of a language generation model that includes an answer to the query.

An “interpretation” of the query is a restatement of the query. The interpretation can explicitly focus on an aspect that is only implicit in the query. An example query is “What is the date of the king's birthday?” Example interpretations of the query include “What is the date of King Charles III's birthday?”, “What is the date of King Philippe's birthday?”, “What is the date of King Abdullah II's birthday?”, etc., where the interpretations make explicit different kings that are implied by “the king” in the query. A “first interpretation” is an interpretation generated based on a query. In some embodiments, a “second interpretation” is an interpretation generated based on a set of text passages.

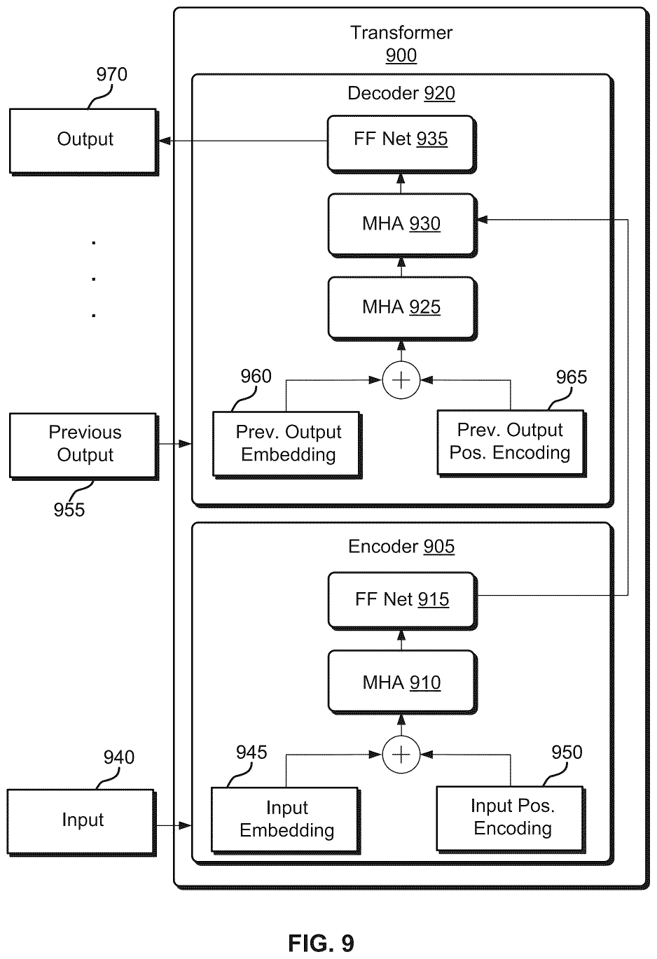

A “language generation model” refers to a machine learning model that is trained to generate a text output based on an input, such as a language model. In some embodiments, the language generation model includes one or more transformers, such as the transformer described with reference to FIG. 9. In some embodiments, the language generation model includes a decoder-only language model, such as a generative pretrained transformer.

A “prompt” is an instruction to a language generation model to generate an output.

An “embedding” is a representation of an object in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar and thus “closer” to each other, thereby allowing a similarity between different objects corresponding to different embeddings to be readily determined.

An “embedding space” (or a “vector space”) refers to a mathematical set having embeddings (or vectors) as components, and is characterized by a dimension specifying a number of independent directions in the embedding space.

An example of the present disclosure is used in a question answering context. In the example, a user provides a query “Who is the top goal-scorer in the soccer world cup?” to the data processing system. The data processing system uses the language generation model to generate the interpretations “1. Who is the top goal-scorer in the men's soccer world cup? 2. Who is the top goal-scorer in the women's soccer world cup?” of the query.

The data processing system identifies a set of documents that relate to the query. The data processing system extracts a set of text passages (a list of men's world cup all time goal leaders, a list of women's world cup all-time goal leaders, a list of top goal-scorers in the men's 2022 world cup, and a list of top goal-scorers in the women's 2023 world cup) from the set of documents based on the interpretations of the query. Because the set of text passages are obtained based on the set of interpretations of the query, rather than the query itself, the set of text passages have a broad scope and are likely to include an answer that accurately reflects a true intent of the query.

The data processing system generates a response to the query using the retrieved text passages as context. The response includes the text, “You may want to know who the all-time goals leader in men's soccer world cup history is, or who the all-time goals leader in women's soccer world cup history is. The top goal-scorer in the history of the men's world cup is German player, Miroslav Klose. And in the women's division, the top goal-scorer is a Brazilian player, most commonly known as Marta. You may also want to know who the top scorer in the most recent world cups were. French player Kylian Mbappé had the most goals in the 2022 men's world cup, while Japanese player Hinata Miyazawa had the most goals in the 2023 women's world cup.”

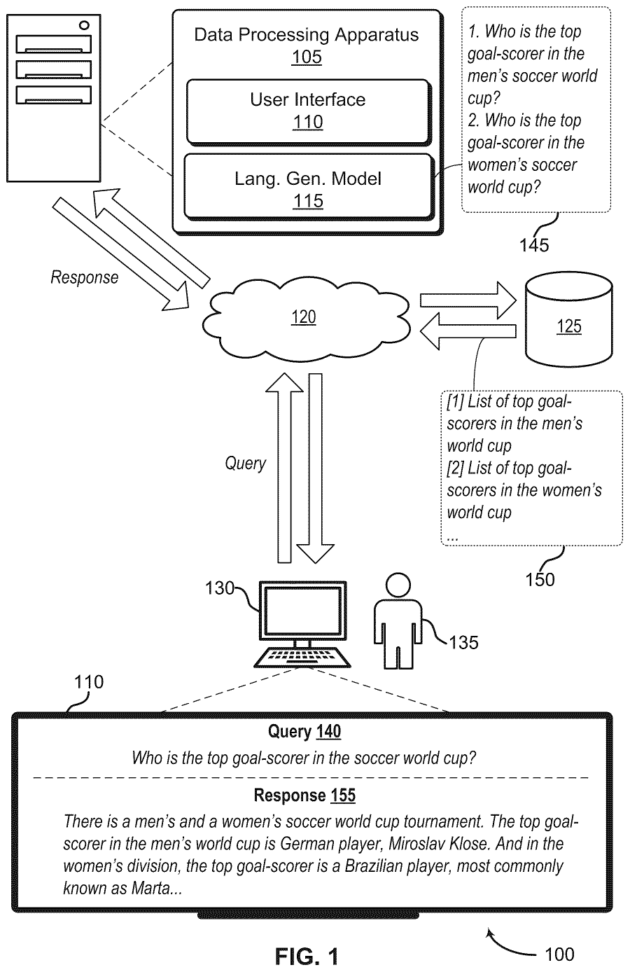

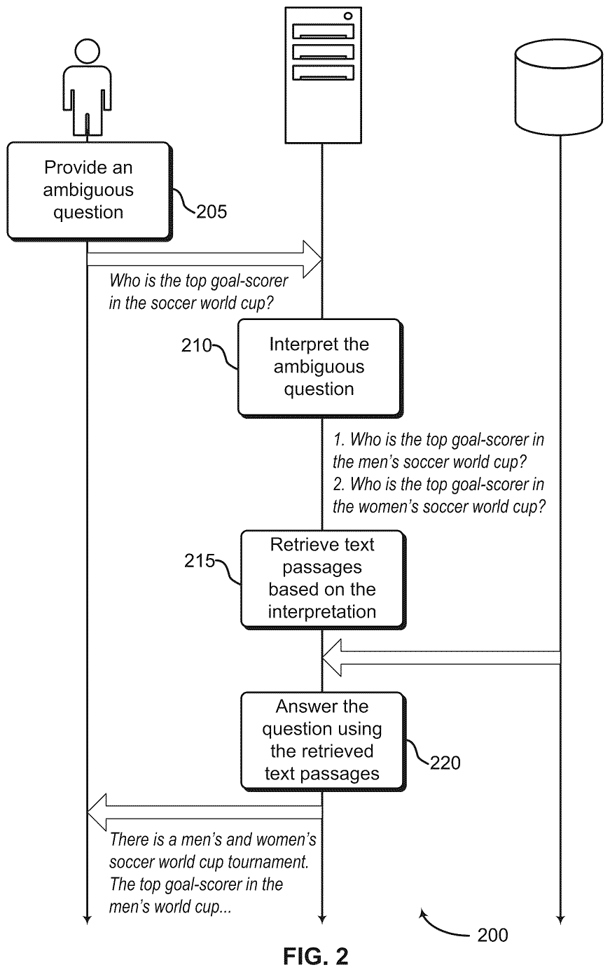

Further examples of the present disclosure in a question answering context are provided with reference to FIGS. 1-2. Details regarding the architecture of the data processing system are provided with reference to FIGS. 1, 3-9, and 15-16. Examples of a process for generating a response to a query are provided with reference to FIGS. 2 and 10-14.

### Data Processing System

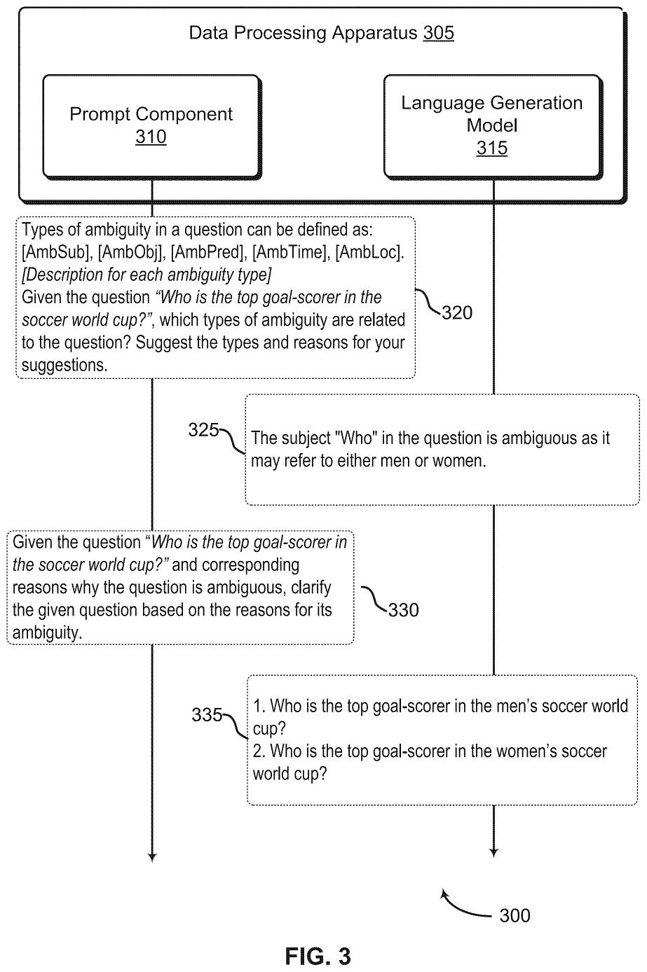

FIG. 1 shows an example of a data processing system 100 for retrieval-augmented question answering according to aspects of the present disclosure. The example shown includes data processing system 100, cloud 120, database 125, user device 130, user 135, query 140, set of first interpretations 145, set of text passages 150, and response 155. Data processing system 100 is an example of, or includes aspects of, the corresponding element described with reference to FIGS. 3 and 6-8. In one aspect, data processing system 100 includes data processing apparatus 105. In one aspect, data processing apparatus 105 includes user interface 110 and language generation model 115.

Referring to FIG. 1, data processing system 100 generates a response (e.g., response 155) to a user query (e.g., query 140) based on a set of text passages (e.g., set of text passages 150) retrieved from database 125 using a set of first interpretations of the query (e.g., set of first interpretations 145). The set of first interpretations are generated by language generation model 115 based on the user query, and are restatements or paraphrases of the user query. The set of first interpretations make implicit understandings of the user query explicit by breaking out the implicit understandings into separate questions. By retrieving the set of text passages based on the set of first interpretations, data processing system 100 encourages a collection of contextual evidence that encompasses each answer that could accurately apply to query 140. Accordingly, because the response is generated using the set of text passages as context, an accuracy of the response is increased.

In the example of FIG. 1, user 135 provides query 140 including the text “Who is the top goal-scorer in the soccer world cup?” to data processing apparatus 105 via user interface 110 displayed on user device 130 by data processing apparatus 105. Language generation model 115 determines that query 140 is ambiguous at least because the query may refer to either the men's world cup or the women's world cup, and generates set of first interpretations 145, including the text “1. Who is the top goal-scorer in the men's soccer world cup? 2. Who is the top goal-scorer in the women's soccer world cup?” based on query 140. The generation of the set of first interpretations is described in further detail with reference to FIGS. 3-5.

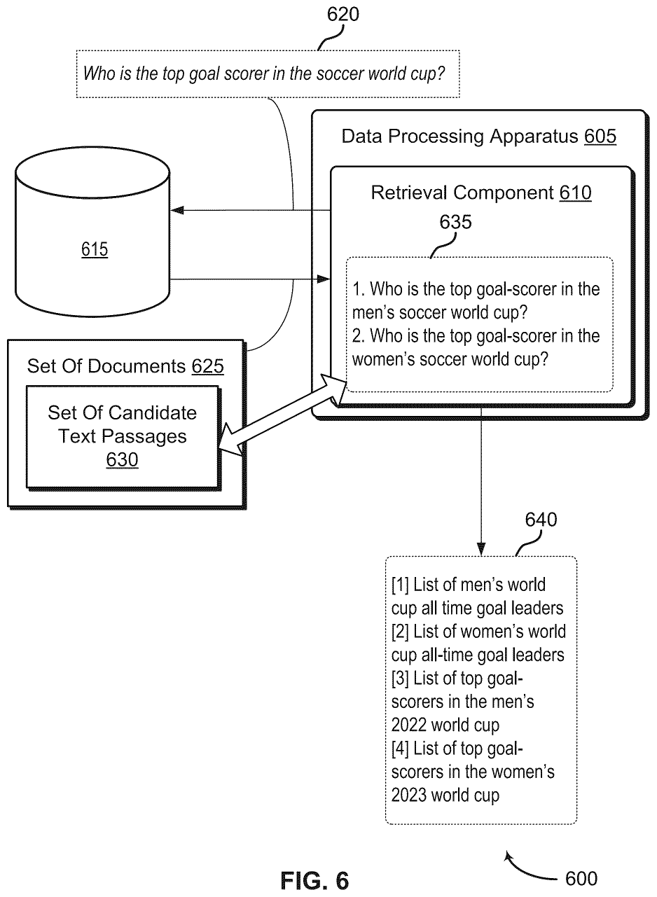

Data processing apparatus 105 retrieves set of text passages 150, including “[1] List of top goal-scorers in the men's world cup [2] List of top goal-scorers in the women's world cup . . . ” (with the content of lists [1] and [2] and further text omitted for the sake of brevity), based on set of first interpretations 145. The retrieval of the set of text passages is described in further detail with reference to FIG. 6.

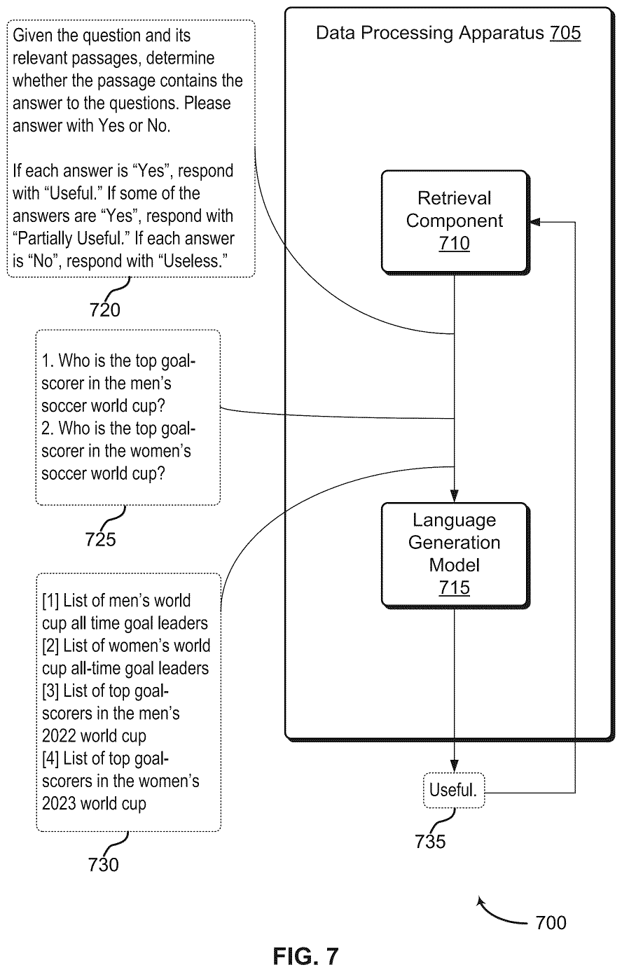

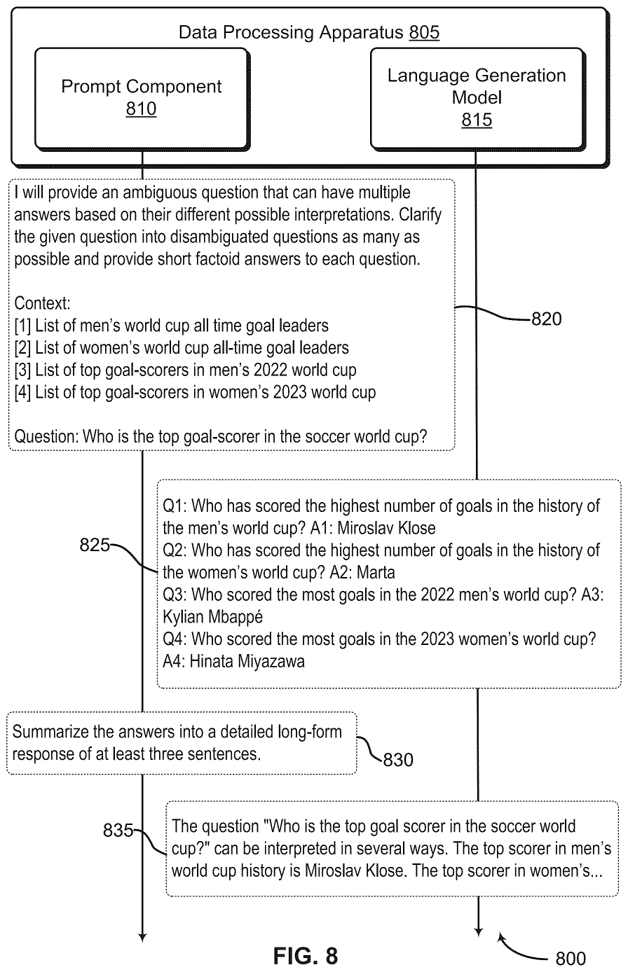

Language generation model 115 generates response 155, including the text “There is a men's and a women's soccer world cup tournament. The top goal-scorer in the men's world cup is German player, Miroslav Klose. And in the women's division, the top goal-scorer is a Brazilian player, most commonly known as Marta . . . ” (with further text omitted for the sake of brevity), using set of text passages 150 as context. The generation of the response is described in further detail with reference to FIG. 8. In some embodiments, the response is generated based on a determination that the set of text passages encompasses at least a portion of the set of first interpretations, as described with reference to FIG. 7. User interface 110 displays response 155 to user 135.

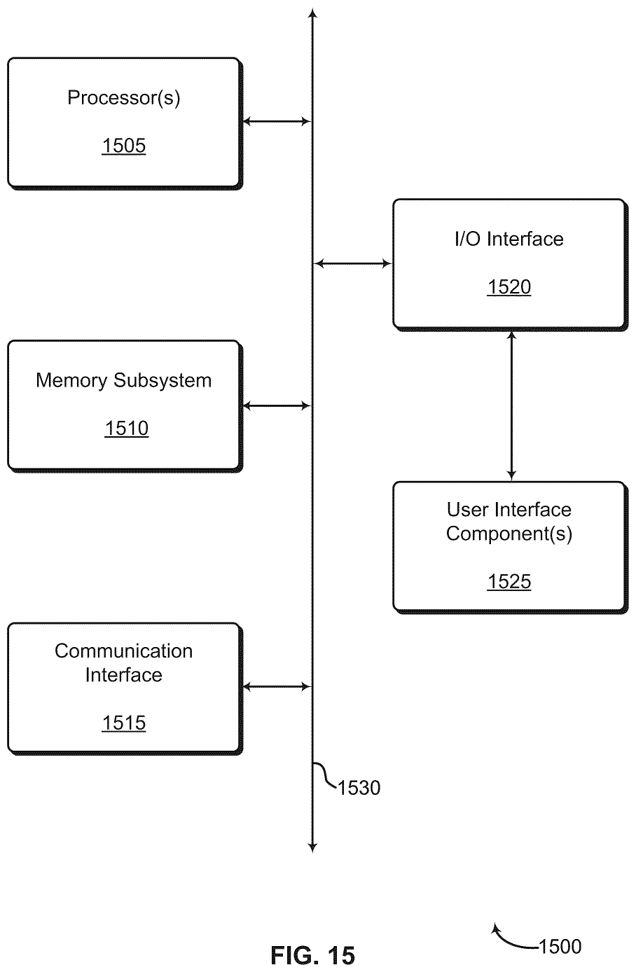

Data processing apparatus 105 is an example of, or includes aspects of, the corresponding element described with reference to FIGS. 3, 6-8, 15, and 16. According to some aspects, data processing apparatus 105 includes a computer-implemented network. In some embodiments, the computer-implemented network includes a machine learning model (such as language generation model 115, described in further detail with reference to FIGS. 3, 7, 8, and 16). In some embodiments, data processing apparatus 105 also includes one or more processors, a memory subsystem, a communication interface, an I/O interface, one or more user interface components, and a bus as described with reference to FIG. 15. Additionally, in some embodiments, data processing apparatus 105 communicates with a user device and database 125 via cloud 120.

According to some aspects, data processing apparatus 105 is implemented on a server. A server provides at least one function to users linked by way of one or more of various networks, such as cloud 120. In some embodiments, the server includes a single microprocessor board, which includes a microprocessor responsible for controlling all aspects of the server. In some embodiments, the server uses microprocessor and protocols to exchange data with other devices or users on one or more of the networks via at least one protocol, such as hypertext transfer protocol (HTTP), simple mail transfer protocol (SMTP), file transfer protocol (FTP), simple network management protocol (SNMP), and the like.

According to some aspects, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

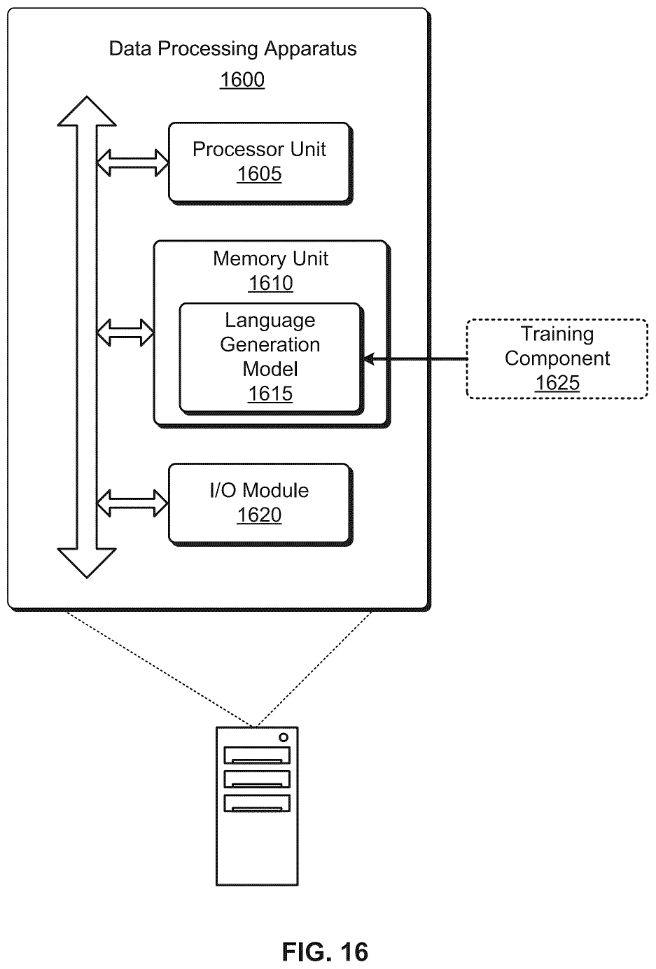

Language generation model 115 is an example of, or includes aspects of, the corresponding element described with reference to FIGS. 3, 7, 8, and 16. According to some aspects, language generation model 115 comprises machine learning parameters stored in a memory unit of data processing apparatus 105 (such as the memory unit 1610 described with reference to FIG. 16).

According to some aspects, language generation model 115 comprises an artificial neural network (ANN) that is able to generate a text output based on a prompt. For example, in some embodiments, language generation model 115 comprises a transformer, such as the transformer described with reference to FIG. 9. In some cases, a transformer comprises an encoder and a decoder. The encoder takes in input data, such as a sentence, and encodes the input into a set of continuous representations or embeddings. The encoder processes the entire input sequence at once, learning relationships between each of the tokens in the sequence. The decoder takes the encoded information as input and generates an output sequence one token at a time. The decoder attends to previous tokens that the decoder has generated, allowing the decoder to make predictions about a next token in a sequence.

According to some aspects, language generation model 115 comprises a decoder-only language model. A decoder-only language model, such as a generative pretrained transformer, omits an encoder and performs autoregressive text generation by predicting one output token at a time based on an input sequence of text, where each prediction is conditioned on tokens that the model has already generated. After generating the first token, the decoder-only language model adds the first token to the input and predicts a next token, continuing the process. The decoder uses self-attention to attend to previously generated tokens, helping the decoder-only language model to understand relationships between each of the tokens in the sequence, allowing the decoder-only language model to generate coherent and contextually appropriate text.

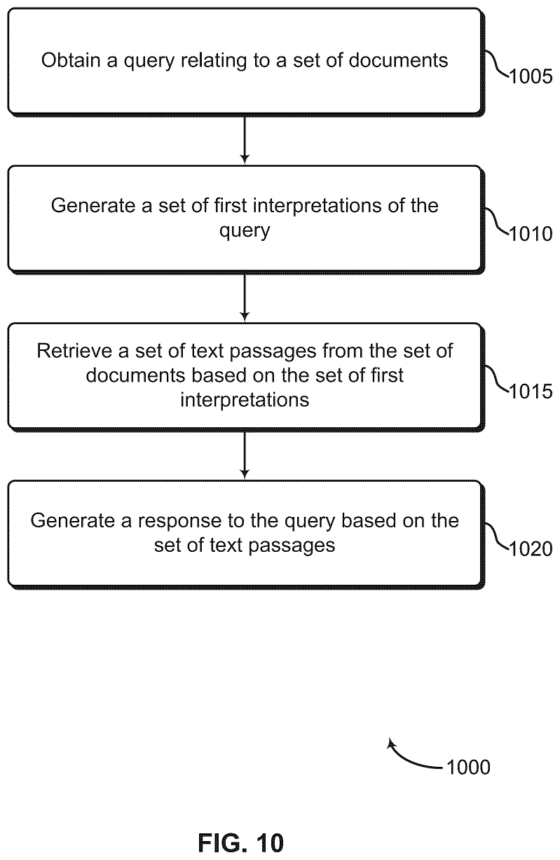

Further detail regarding the architecture of a data processing system are provided with reference to FIGS. 3-9 and 15-16. Further detail regarding a processes for generating a response to a user query is provided with reference to FIGS. 10-14.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if the server has a direct or close connection to a user. In some examples, cloud 120 is limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between data processing apparatus 105, database 125, and the user device.

Database 125 is an example of, or includes aspects of, the corresponding element described with reference to FIG. 6. In some aspects, the set of text passages are stored in database 125 and the set of text passages are retrieved from database 125. Database 125 is an organized collection of data. In an example, database 125 stores data in a specified format known as a schema. According to some aspects, database 125 is structured as a single database, a distributed database, multiple distributed databases, or an emergency backup database. Data storage and processing in database 125 is manageable by a database controller, which can be operated by a user or automatically without interaction from the user. According to some aspects, database 125 is included in data processing apparatus 105. According to some aspects, database 125 is external to data processing apparatus 105 and communicates with data processing apparatus 105 via cloud 120.

According to some aspects, the user device is a personal computer, laptop computer, mainframe computer, palmtop computer, personal assistant, mobile device, or any other suitable processing apparatus. In some examples, the user device includes software that displays user interface 110 provided by data processing apparatus 105. User interface 110 allows information to be communicated between the user and data processing apparatus 105. According to some aspects, user interface 110 comprises a text interface, a graphical user interface, or a combination thereof.

According to some aspects, a user device user interface enables a user to interact with the user device. In some embodiments, the user device user interface includes an audio device, such as an external speaker system, an external display device such as a display screen, or an input device (e.g., a remote-control device interfaced with the user interface directly or through an I/O controller module). In some cases, the user device user interface is a graphical user interface.

Query 140 is an example of, or includes aspects of, the corresponding element described with reference to FIG. 6. Set of text passages 150 is an example of, or includes aspects of, the corresponding element described with reference to FIGS. 6 and 7. Response 155 is an example of, or includes aspects of, the corresponding element described with reference to FIG. 8.

FIG. 2 shows an example of a method 200 for retrieval-augmented question answering for ambiguous questions according to aspects of the present disclosure. Referring to FIG. 2, a data processing system (such as the data processing system 100 described with reference to FIG. 1) performs method 200 to generate a set of interpretations of an ambiguous user query, and uses the set of interpretations to retrieve a set of text passages from a database. The set of text passages are used as context by a language generation model to generate a response to the user query. Because the set of text passages are retrieved based on the set of interpretations, the set of text passages are diversified and encompass answers for the multiple interpretations of the user query, which increases an accuracy of the generated response.

At operation 205, a user provides an ambiguous question. In an example, a user (such as the user 135 described with reference to FIG. 1) provides the ambiguous question (e.g., a query) to a data processing apparatus (e.g., data processing apparatus 105 described with reference to FIG. 1) via a user interface of the data processing apparatus (e.g., user interface 110 described with reference to FIG. 1.

At operation 210, the system interprets the ambiguous question. In some cases, the operations of this step refer to, or is performed by, a data processing apparatus as described with reference to FIGS. 1, 3, 6-8, and 15-16. In an example, the data processing apparatus interprets the ambiguous question by using a language generation model to generate a set of first interpretations based on the ambiguous question as described with reference to FIG. 3.

At operation 215, the system retrieves text passages based on the interpretation. In some cases, the operations of this step refer to, or is performed by, a data processing apparatus as described with reference to FIGS. 1, 3, 6-8, and 15-16. In an example, the data processing apparatus retrieves the text passages based on the interpretation by retrieving a set of text passages based on the set of first interpretations as described with reference to FIG. 6.

At operation 220, the system answers the question using the retrieved text passages. In some cases, the operations of this step refer to, or is performed by, a data processing apparatus as described with reference to FIGS. 1, 3, 6-8, and 15-16. In an example, the system answers the question using the retrieved text passages by generating a response to the ambiguous question using the set of text passages as context as described with reference to FIG. 8.

FIG. 3 shows an example of a data processing system 300 for generating a set of first interpretations according to aspects of the present disclosure. The example shown includes data processing system 300, first prompt 320, intermediate response 325, second prompt 330, and set of first interpretations 335. In one aspect, data processing system 300 includes data processing apparatus 305. In one aspect, data processing apparatus 305 includes prompt component 310 and language generation model 315.

Referring to FIG. 3, data processing system 300 generates a set of first interpretations [symbol] ᵢ (e.g., set of first interpretations 335) that are used by data processing system 600 to efficiently identify text passages [symbol] ᵢ that encompass each plausible answer [symbol] ᵢ for a user query qᵢ as described with reference to FIG. 6.

According to some aspects, data processing system 300 infers the set of first interpretations [symbol] ᵢ={\hat{q}_{i,1}, \hat{q}_{i,2}, . . . } of a query qᵢ, where each first interpretation \hat{q}_{i,j} is related to a true plausible answer [symbol] ᵢ for the query qᵢ. For example, data processing system 300 first identifies how the query qᵢ is ambiguous, and then determines a reason for the ambiguity, followed by inferring the set of first interpretations [symbol] ᵢ of the query qᵢ based on the reason for the ambiguity. In an example, given a query qᵢ, “Who is the top goal-scorer in the soccer world cup?”, data processing system 300 identifies that the query qᵢ is ambiguous because a portion of the object of the query qᵢ, “soccer world cup”, may refer to either the men's soccer world cup or the women's soccer world cup, and also that the time frame of the predicate of the query qᵢ, “is the top goal-scorer in the soccer world cup”, is ambiguous because it is not clear if the predicate is referring to all world cups in aggregate or only to the most recent world cup.

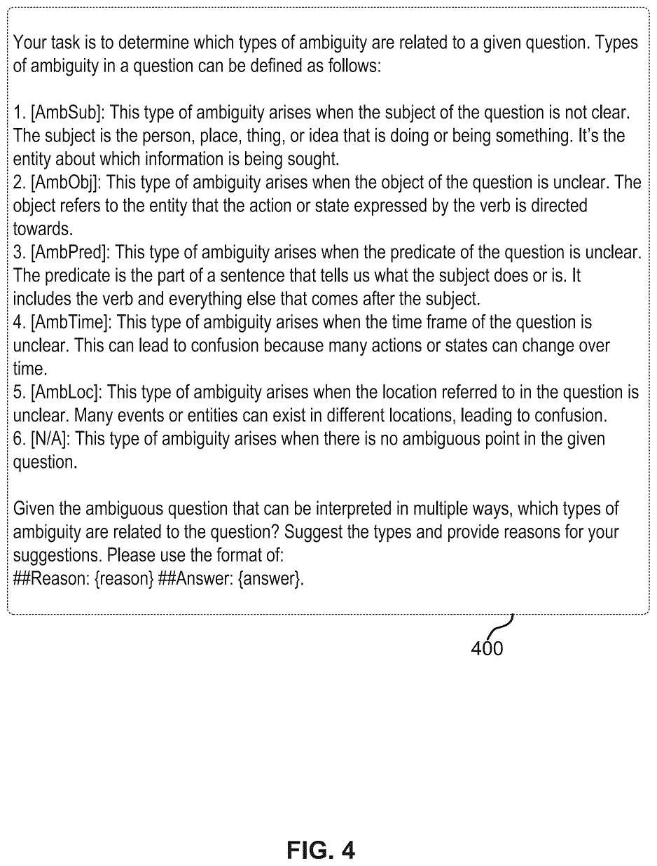

In some embodiments, prompt component 310 generates a first prompt Iₐ (e.g., first prompt 320) including the query and a set of candidate ambiguity types. The first prompt Iₐ can include an instruction to identify which types of ambiguity are related to a received query qᵢ. For example, first prompt 320 includes the text, “Types of ambiguity in a question can be defined as: [AmbSub], [AmbObj], [AmbPred], [AmbTime], [AmbLoc]. [Description for each ambiguity type]. Given the question ‘Who is the top goal-scorer in the soccer world cup?’ which types of ambiguity are related to the question? Suggest the types and reasons for your suggestions.” An example first prompt is described in further detail with reference to FIG. 4.

Language generation model 315 generates an intermediate response (e.g., intermediate response 325) based on the first prompt. In an example, intermediate response 325 includes the text, “The subject ‘Who’ in the question is ambiguous as it may refer to either men or women.”” In some embodiments, the intermediate response includes an identification of multiple types of ambiguities.

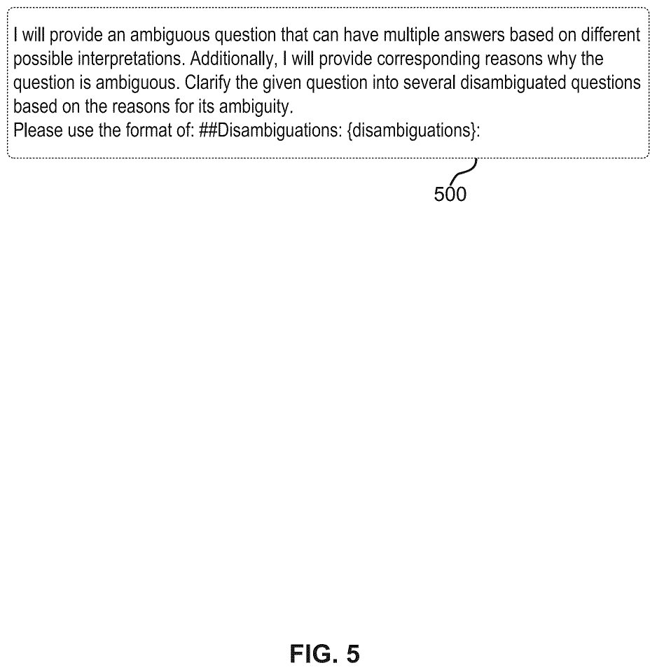

Then, prompt component 310 generates a second prompt Iₚ (e.g., second prompt 330) including the query and an instruction to clarify the query based on the intermediate response. For example, second prompt 330 includes the text “Given the question ‘Who is the top goal-scorer in the soccer world cup?’ and corresponding reasons why the question is ambiguous, clarify the given question based on the reasons for its ambiguity.” An example second prompt is described in further detail with reference to FIG. 5.

Language generation model 315 generates the set of first interpretations [symbol] ᵢ based on the second prompt Iₚ and the intermediate response:

$${Q}_{i} ← LGM ( {q}_{i} , {I}_{p} , LGM ( {q}_{i} , {I}_{a} ) ) \qquad ( 1 )$$

In an example, set of first interpretations 335 includes a first interpretation “1. Who is the top goal-scorer in the men's soccer world cup?” and an additional first interpretation “2. Who is the top goal-scorer in the women's soccer world cup?” Set of first interpretations 335 therefore includes interpretations of the user query qᵢ.

Data processing system 300 is an example of, or includes aspects of, the corresponding element described with reference to FIGS. 1 and 6-8. Data processing apparatus 305 is an example of, or includes aspects of, the corresponding element described with reference to FIGS. 1, 6-8, 15, and 16. Prompt component 310 is an example of, or includes aspects of, the corresponding element described with reference to FIG. 8. Language generation model 315 is an example of, or includes aspects of, the corresponding element described with reference to FIGS. 1, 7, 8, and 16.

First prompt 320 is an example of, or includes aspects of, the corresponding element described with reference to FIG. 4. Second prompt 330 is an example of, or includes aspects of, the corresponding element described with reference to FIG. 5. Set of first interpretations 335 is an example of, or includes aspects of, the corresponding element described with reference to FIGS. 6 and 7.

FIG. 4 shows an example of a first prompt 400 according to aspects of the present disclosure. First prompt 400 is an example of, or includes aspects of, the corresponding element described with reference to FIG. 3. Referring to FIG. 4, first prompt 400 is an example of a first prompt Iₐ that includes a query (e.g., a question) and a set of candidate ambiguity types (e.g., [AmbSub], [AmbObj], etc.), along with definitions of the candidate ambiguity types.

FIG. 5 shows an example of a second prompt 500 according to aspects of the present disclosure. Second prompt 500 is an example of, or includes aspects of, the corresponding element described with reference to FIG. 3. Referring to FIG. 5, second prompt 500 is an example of a second prompt In that includes a query (e.g., a question) and an instruction to clarify the query based on an intermediate response (e.g., the “reasons for [the query's] ambiguity”.

FIG. 6 shows an example of a data processing system 600 for retrieving relevant and diverse passages according to aspects of the present disclosure. The example shown includes data processing system 600, query 620, set of documents 625, set of first interpretations 635, and set of text passages 640. In one aspect, data processing system 600 includes data processing apparatus 605 and database 615. In one aspect, data processing apparatus 605 includes retrieval component 610. In one aspect, set of documents 625 includes set of candidate text passages 630.

Referring to FIG. 6, retrieval component 610 obtains a set of documents (e.g., set of documents 625) including a set of candidate text passages [symbol] ᵢ, or the text included in the set of documents (e.g., set of candidate text passages 630), that are generally relevant to a query qᵢ from database 615. For example, the set of documents is obtained using word matching between the query qᵢ and set of candidate text passages [symbol] ᵢ, or any other appropriate search technique or algorithm.

Retrieval component 610 selects a set of text passages set of text passages [symbol] ᵢ that includes a maximal coverage of the set of first interpretations [symbol] ᵢ (e.g., set of first interpretations 635). A comparative process retrieval process involves scoring a text passage individually based on a relevance to a user query. By contrast, in some embodiments, data processing system 600 retrieves a set of text passages that encompass multiple interpretations of an ambiguous query. For example, retrieval component 610 retrieves the set of text passages [symbol] ᵢ from the set of candidate text passages [symbol] ᵢ based on the set of first interpretations [symbol] ᵢ:

$${𝒫}_{i} ← {{⋃}^{\vert {\hat{Q}}_{i} \vert}}_{j = 1} ℛ ( {𝒞}_{i} , {\hat{q}}_{i , j} ; K ) \qquad ( 2 )$$

[symbol] is a retriever yielding top-K passages from the set of candidate passages [symbol] ᵢ by relevance scores to each first interpretation \hat{q}_{i,j}. In some embodiments, the retriever R is implemented as a sentence encoder (e.g., a machine learning model including parameters stored in a memory unit of data processing apparatus 605, such as the memory unit 1610 described with reference to FIG. 16). In an example, retrieval component 610 uses the retriever [symbol] to generate embeddings of the set of candidate passages [symbol] ᵢ and each first interpretation \hat{q}_{i,j} and determines relevance scores (e.g., similarity scores) for the set of candidate passages [symbol] ᵢ and each first interpretation \hat{q}_{i,j} based on comparisons of the embeddings.

This process allows the set of text passages [symbol] ᵢ to encompass the set of first interpretations [symbol] ᵢ. In an example, set of text passages 640 retrieved from set of candidate text passages 630 based on set of first interpretations 635 includes a list of men's world cup all time goal leaders, a list of women's world cup all-time goal leaders, a list of top goal-scorers in the men's 2022 world cup, and a list of top goal-scorers in the women's 2023 world cup.

In some embodiments, retrieval component 610 finds and prunes noisy or irrelevant text passages from the set of text passages [symbol] ᵢ by measuring an averaged relevance score [symbol] (p) of each of the text passages p:

$$S ( p ) ← \frac{1}{\vert {\hat{Q}}_{i} \vert} {{\sum }^{\vert {\hat{Q}}_{i} \vert}}_{j = 1} \frac{Enc ( {\hat{q}}_{j} ) Enc ( p )}{‖ Enc ( {\hat{q}}_{j} ) ‖ \cdot ‖ Enc ( p ) ‖} \qquad ( 3 )$$

Enc(⋅) is an encoder (e.g., the sentence encoder) that encodes sentences to a dense vector, and pϵ [symbol] ᵢ. Retrieval component removes the bottom-K text passages p from the set of text passages [symbol] ᵢ based on the averaged relevance scores [symbol] (p).

According to some aspects, a data processing system 700 verifies retrieved text passages of the set of text passages [symbol] ᵢ as described with reference to FIG. 7. According to some aspects, data processing system 800 generates a response based on the set of text passages [symbol] ᵢ as described with reference to FIG. 8.

Data processing system 600 is an example of, or includes aspects of, the corresponding element described with reference to FIGS. 1, 3, 7, and 8. Data processing apparatus 605 is an example of, or includes aspects of, the corresponding element described with reference to FIGS. 1, 3, 7, 8, 15, and 16. Retrieval component 610 is an example of, or includes aspects of, the corresponding element described with reference to FIG. 7. Database 615 is an example of, or includes aspects of, the corresponding element described with reference to FIG. 1.

Query 620 is an example of, or includes aspects of, the corresponding element described with reference to FIG. 1. Set of first interpretations 635 is an example of, or includes aspects of, the corresponding element described with reference to FIGS. 3 and 7. Set of text passages 640 is an example of, or includes aspects of, the corresponding element described with reference to FIGS. 1 and 7.

FIG. 7 shows an example of a data processing system 700 for retrieval verification according to aspects of the present disclosure. The example shown includes data processing system 700, retrieval verification prompt 720, set of first interpretations 725, set of text passages 730, and text passages classification 735. In one aspect, data processing system 700 includes data processing apparatus 705. In one aspect, data processing apparatus 705 includes retrieval component 710 and language generation model 715.

Referring to FIG. 7, according to some aspects, retrieval component 710 determines whether a set of text passages [symbol] ᵢ (e.g., set of text passages 730) encompasses a set of first interpretations [symbol] ᵢ (e.g., set of first interpretations 725). In some embodiments, if the set of text passages [symbol] ᵢ encompasses at least a portion of the set of first interpretations [symbol] ᵢ, data processing system 800 generates a response based on the set of text passages [symbol] ᵢ as described with reference to FIG. 8. In some embodiments, if the set of text passages [symbol] ᵢ does not encompass at least a portion of the set of first interpretations [symbol] ᵢ, a data processing system disregards the set of text passages [symbol] ᵢ and generates a response to a query qᵢ using a language generation model's internal knowledge. This process enables a utilization of a most suitable approach tailored to a retrieval quality of the set of text passages [symbol] ᵢ, which is beneficial to both an accuracy and efficiency of answer generation.

For example, retrieval component 710 determines which of the set of first interpretations [symbol] ᵢ have answers that are encompassed by the set of text passages [symbol] ᵢ based on respective outputs V_{i,j} of language generation model 715:

$$\begin{matrix}{v}_{I , 1} ← LGM ( {\hat{q}}_{i , 1} , {𝒫}_{i} , {I}_{v} ) \\ ⋮ \\ {V}_{i , \vert {\hat{Q}}_{i} \vert} ← LGM ( {\hat{q}}_{i , \vert {\hat{Q}}_{i} \vert} , {𝒫}_{i} , {I}_{v} )\end{matrix} \qquad ( 4 )$$

Retrieval verification prompt Iᵥ is a prompt provided by retrieval component 710 instructing language generation model 715 to generate an output to determine the classifications V_{i,j} of the set of text passages, where each V_{i,j} includes a binary label (i.e., “Yes” or “No”), and to determine whether the classifications V_{i,j} indicate that the set of text passages [symbol] ᵢ are “Useful” (i.e., that the set of text passages [symbol] ᵢ encompass answers for each of the set of first interpretations [symbol] ᵢ), “Partially Useful” (i.e., that the set of text passages [symbol] ᵢ encompass answers for some of the set of first interpretations \hat{Q}ᵢ), or “Useless” (i.e., that the set of text passages [symbol] ᵢ encompass answers for none of the set of first interpretations [symbol] ᵢ).

For example, retrieval verification prompt 720 includes the text, “Given the question and its relevant passages, determine whether the passage contains the answer to the questions. Please answer with Yes or No. If each answer is ‘Yes’, respond with ‘Useful.’ If some of the answers are ‘Yes’, respond with ‘Partially Useful.’ If each answer is ‘No’, respond with ‘Useless.’”. In the example of FIG. 7, language generation model 715 generates text passages classification 735, “Useful.”, indicating that set of text passages 730 encompasses answers for each of the set of first interpretations 725.

Retrieval component 710 receives the text passages classification. Retrieval component 710 determines that data processing system 700 should proceed with generating an answer based on the set of text passages [symbol] ᵢ when the text passages classification includes “Useful” or “Partially Useful”. Retrieval component 710 determines that data processing system 700 should proceed with generating an answer based on an internal memory of language generation model 715 when the text passages classification includes “Useless”. In the example of FIG. 7, because text passages classification 735 includes “Useful”, retrieval component 710 determines that data processing system 800 should proceed to generate a response based on the set of text passages [symbol] ᵢ as described with reference to FIG. 8.

While some existing works verify whether a single text passage can sufficiently support answering an unambiguous question by using a comparative language model, data processing system 700 grades a retrieval quality for an ambiguous question according to how many interpretations of the ambiguous question have answers that are encompassed by a set of retrieved text passages.

Data processing system 700 is an example of, or includes aspects of, the corresponding element described with reference to FIGS. 1, 3, 6, and 8. Data processing apparatus 705 is an example of, or includes aspects of, the corresponding element described with reference to FIGS. 1, 3, 6, 8, 15, and 16. Retrieval component 710 is an example of, or includes aspects of, the corresponding element described with reference to FIG. 6. Language generation model 715 is an example of, or includes aspects of, the corresponding element described with reference to FIGS. 1, 3, 8, and 16.

Set of first interpretations 725 is an example of, or includes aspects of, the corresponding element described with reference to FIGS. 3 and 6. Set of text passages 730 is an example of, or includes aspects of, the corresponding element described with reference to FIGS. 1 and 6.

FIG. 8 shows an example of a data processing system 800 for response generation according to aspects of the present disclosure. The example shown includes data processing system 800, third prompt 820, set of second interpretations and answers 825, fourth prompt 830, and response 835. In one aspect, data processing system 800 includes data processing apparatus 805. In one aspect, data processing apparatus 805 includes prompt component 810 and language generation model 815.

Referring to FIG. 8, data processing system 800 generates a response rᵢ (e.g., response 835) to a user query qᵢ using a set of text passages [symbol] ᵢ retrieved as described with reference to FIG. 6 as context.

According to some aspects, prompt component 810 generates a third prompt Iₑ (e.g., third prompt 820) including the query qᵢ and the set of text passages [symbol] ᵢ and instructing language generation model 815 to generate a set of second interpretations [symbol] ᵢ={q_{i,1}, . . . q_{i,M}} and answers [symbol] ᵢ={a_{i,1}, . . . a_{i,M}} to the set of second interpretations (e.g., set of second interpretations and answers 825) using the set of text passages [symbol] ᵢ as context. For example, third prompt 820 includes the text, “I will provide an ambiguous question that can have multiple answers based on their different possible interpretations. Clarify the given question into disambiguated questions as many as possible and provide short factoid answers to each question. Context: [1] List of men's world cup all time goal leaders [2] List of women's world cup all-time goal leaders [3] List of top goal-scorers in the men's 2022 world cup [4] List of top goal-scorers in women's 2023 world cup Question: Who is the top goal-scorer in the soccer world cup?” The full text of lists [1]-[4] is omitted for the sake of brevity. In some embodiments, the query qᵢ and the set of text passages [symbol] ᵢ are omitted from the third prompt Iₑ, and the query qᵢ, the set of text passages [symbol] ᵢ, and the third prompt Iₑ are provided separately to language generation model 815.

Language generation model 815 generates the set of second interpretations [symbol] ᵢ and corresponding answers [symbol] ᵢ based on the third prompt Iₑ (or the query qᵢ, the set of text passages [symbol] ᵢ, and the third prompt Iₑ):

$${Q}_{i} , {𝒜}_{i} ← LGM ( {q}_{i} , {𝒫}_{i} , {I}_{e} ) \qquad ( 5 )$$

For example, set of second interpretations and answers 825 includes the text, “Q1: Who has scored the highest number of goals in the history of the men's world cup? A1: Miroslav Klose Q2: Who has scored the highest number of goals in the history of the women's world cup? A2: Marta Q3: Who scored the most goals in the 2022 men's world cup? A3: Kylian Mbappé Q4: Who scored the most goals in the 2023 women's world cup? A4: Hinata Miyazawa”.

Subsequently, prompt component 810 generates a fourth prompt I_{g} (e.g., fourth prompt 830) instructing language generation model 815 to generate a response rᵢ based on the set of answers [symbol] ᵢ. For example, fourth prompt 830 includes the text, “Summarize the answers into a detailed long-form response of at least three sentences.”

Language generation model 815 generates the response rᵢ based on the set of answers [symbol] ᵢ:

$${r}_{i} ← L G M ( {Q}_{i} , {𝒜}_{i} , {𝒫}_{i} , {q}_{i} , {I}_{g} ) \qquad ( 6 )$$

For example, response 835 includes the text, “The question “Who is the top goal-scorer in the soccer world cup?” can be interpreted in several ways. The top scorer in men's world cup history is Miroslav Klose. The top scorer in women's . . . ” The remainder of response 835 is omitted for the sake of brevity.

Data processing system 800 is an example of, or includes aspects of, the corresponding element described with reference to FIGS. 1, 3, 6, and 7. Data processing apparatus 805 is an example of, or includes aspects of, the corresponding element described with reference to FIGS. 1, 3, 6, 7, 15, and 16. Prompt component 810 is an example of, or includes aspects of, the corresponding element described with reference to FIGS. 3 and 7. Language generation model 815 is an example of, or includes aspects of, the corresponding element described with reference to FIGS. 1, 3, 7, and 16. Response 835 is an example of, or includes aspects of, the corresponding element described with reference to FIG. 1.

FIG. 9 shows an example of a transformer 900 according to aspects of the present disclosure. The example shown includes encoder 905, decoder 920, input 940, input embedding 945, input positional encoding 950, previous output 955, previous output embedding 960, previous output positional encoding 965, and output 970. According to some aspects, transformer 900 comprises architectural elements of the language generation model described with reference to FIGS. 1, 3, 7, 8, and 16.

According to some aspects, a transformer comprises one or more ANNs comprising attention mechanisms that enable the transformer to weigh an importance of different words or tokens within a sequence. In some examples, a transformer processes entire sequences simultaneously in parallel using multiple attention heads, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures that enables an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

Encoder 905 includes multi-head self-attention sublayer 910 and feed-forward network sublayer 915. Decoder 920 includes first multi-head self-attention sublayer 925, second multi-head self-attention sublayer 930, and feed-forward network sublayer 935.

Encoder 905 is configured to map input 940 (for example, a prompt, a query, a set of text passages, an answer, or a combination thereof) to a sequence of continuous representations that are fed into decoder 920. Decoder 920 generates output 970 (e.g., a prediction of an output sequence of words or tokens) based on the output of encoder 905 and previous output 955 (e.g., a previously predicted output sequence), which allows for the use of autoregression.

For example, encoder 905 parses input 940 into tokens and vectorizes the parsed tokens to obtain input embedding 945, and adds input positional encoding 950 (e.g., positional encoding vectors for input 940 of a same dimension as input embedding 945) to input embedding 945. Input positional encoding 950 includes information about relative positions of words or tokens in input 940.

Encoder 905 comprises one or more encoding layers that generate contextualized token representations, where each representation corresponds to a token that combines information from other input tokens via self-attention mechanism. Each encoding layer of encoder 905 comprises a multi-head self-attention sublayer (e.g., multi-head self-attention sublayer 910). The multi-head self-attention sublayer implements a multi-head self-attention mechanism that receives different linearly projected versions of queries, keys, and values to produce outputs in parallel at each attention head of transformer 900. Each encoding layer of encoder 905 also includes a fully connected feed-forward network sublayer (e.g., feed-forward network sublayer 915) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 7 )$$

Each layer employs different weight parameters (W₁, W₂) and different bias parameters (b₁, b₂) to apply a same linear transformation to each word or token in input 940.

Each sublayer of encoder 905 is followed by a normalization layer that normalizes a sum computed between a sublayer input x and an output sublayer(x) generated by the sublayer:

$$layernorm ( x + sublayer ( x ) ) \qquad ( 8 )$$

Encoder 905 is bidirectional because encoder 905 attends to each word or token in input 940 regardless of a position of the word or token in input 940.

Decoder 920 comprises one or more decoding layers (e.g., six decoding layers). Each decoding layer comprises three sublayers including a first multi-head self-attention sublayer (e.g., first multi-head self-attention sublayer 925), a second multi-head self-attention sublayer (e.g., second multi-head self-attention sublayer 930), and a feed-forward network sublayer (e.g., feed-forward network sublayer 935). Each sublayer of decoder 920 is followed by a normalization layer that normalizes a sum computed between a sublayer input x and an output sublayer(x) generated by the sublayer.

Decoder 920 generates previous output embedding 960 of previous output 955 and adds previous output positional encoding 965 (e.g., position information for words or tokens in previous output 955) to previous output embedding 960. Each first multi-head self-attention sublayer receives the combination of previous output embedding 960 and previous output positional encoding 965 and applies a multi-head self-attention mechanism to the combination. For each word in an input sequence, each first multi-head self-attention sublayer of decoder 920 attends only to words preceding the word in the sequence, and so a prediction of transformer 900 for a word at a particular position only depends on known outputs for a word that came before the word in the sequence. In some cases, each first multi-head self-attention sublayer implements multiple single-attention functions in parallel by introducing a mask over values produced by the scaled multiplication of matrices Q and K by suppressing matrix values that would otherwise correspond to disallowed connections.

Each second multi-head self-attention sublayer implements a multi-head self-attention mechanism similar to the multi-head self-attention mechanism implemented in each multi-head self-attention sublayer of encoder 905 by receiving a query Q from a previous sublayer of decoder 920 and a key K and a value V from the output of encoder 905, allowing decoder 920 to attend to each word in the input 940.

Each feed-forward network sublayer implements a fully connected feed-forward network similar to feed-forward network sublayer 915. The feed-forward network sublayers are followed by a linear transformation and a softmax to generate a prediction of output 970.

### Retrieval-Augmented Question Answering

FIG. 10 shows an example of a method 1000 for generating a response to a query based on a set of retrieved text passages according to aspects of the present disclosure. Referring to FIG. 10, a data processing system (such as the data processing system 100 described with reference to FIG. 1) performs method 1000 to generate a set of interpretations of a user query, and uses the set of interpretations to retrieve a set of text passages from a database. The set of text passages are used as context by a language generation model to generate a response to the user query. Because the set of text passages are retrieved based on the set of interpretations, the set of text passages are diversified and encompass answers for the multiple interpretations of the user query, which increases an accuracy of the generated response (especially where the user query is ambiguous, or capable of being interpreted in multiple ways).

At operation 1005, the system obtains a query relating to a set of documents. In some cases, the operations of this step refer to, or is performed by, a data processing apparatus as described with reference to FIGS. 1, 3, 6-8, 15, and 16. In an example, a user provides the query via a user interface of the data processing apparatus as described with reference to FIG. 1.

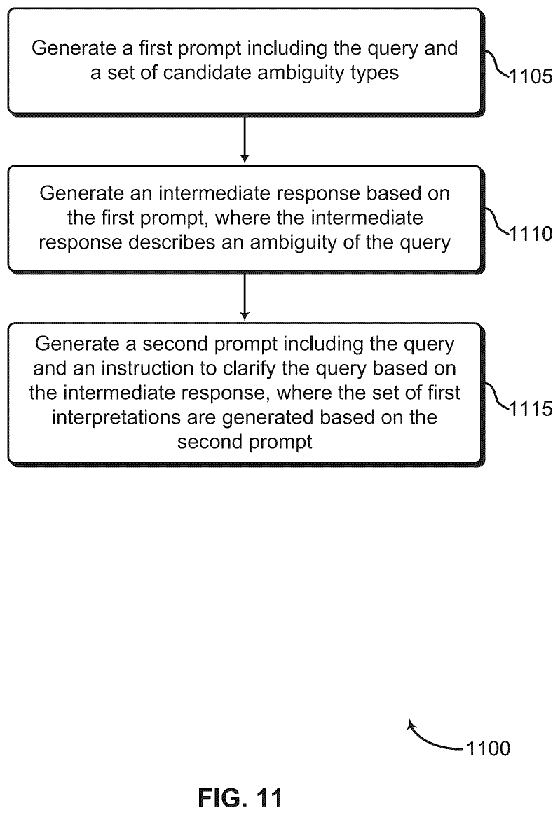

At operation 1010, the system generates a set of first interpretations of the query. In some cases, the operations of this step refer to, or is performed by, a language generation model as described with reference to FIGS. 1, 3, 7, 8, and 16. In an example, the language generation model generates the set of first interpretations of the query as described with reference to FIG. 3. According to some aspects, the language generation model generates the set of first interpretations as described with reference to FIG. 11.

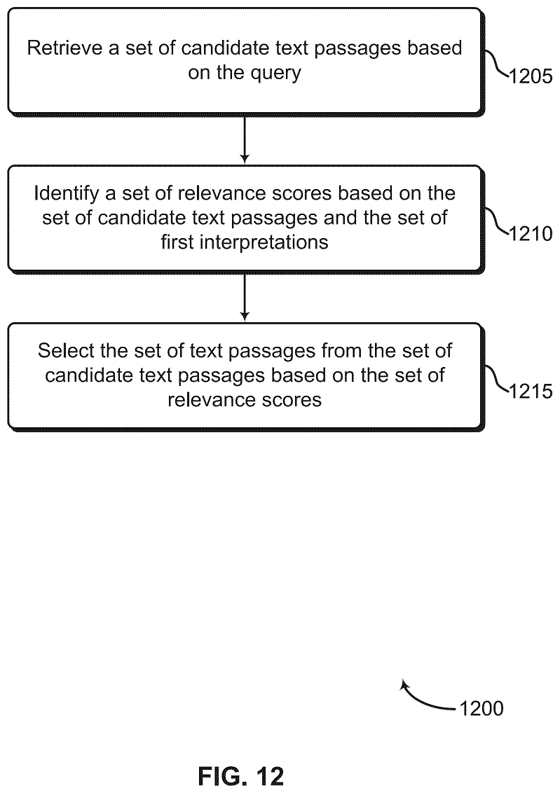

At operation 1015, the system retrieves a set of text passages from the set of documents based on the set of first interpretations. In some cases, the operations of this step refer to, or is performed by, a retrieval component as described with reference to FIGS. 6 and 7. In an example, the retrieval component retries the set of text passages as described with reference to FIG. 6. According to some aspects, the retrieval component retrieves the set of text passages as described with reference to FIG. 12.

At operation 1020, the system generates a response to the query based on the set of text passages. In some cases, the operations of this step refer to, or is performed by, a language generation model as described with reference to FIGS. 1, 3, 7, 8, and 16. In an example, the language generation model generates the response as described with reference to FIG. 8. In some embodiments, the retrieval component determines whether the set of text passages encompasses the set of first interpretations as described with reference to FIG. 7, where the response is generated based on the determination.

FIG. 11 shows an example of a method 1100 for generating a set of first interpretations according to aspects of the present disclosure.

At operation 1105, the system generates a first prompt including the query and a set of candidate ambiguity types. In some cases, the operations of this step refer to, or is performed by, a prompt component as described with reference to FIGS. 3 and 8. In an example, the prompt component generates the first prompt as described with reference to FIG. 3.

At operation 1110, the system generates an intermediate response based on the first prompt, where the intermediate response describes an ambiguity of the query. In some cases, the operations of this step refer to, or is performed by, a language generation model as described with reference to FIGS. 1, 3, 7, 8, and 16. In an example, the prompt component generates the intermediate response as described with reference to FIG. 3.

At operation 1115, the system generates a second prompt including the query and an instruction to clarify the query based on the intermediate response, where the set of first interpretations are generated based on the second prompt. In some cases, the operations of this step refer to, or is performed by, a prompt component as described with reference to FIGS. 3 and 8. In an example, the prompt component generates the second prompt as described with reference to FIG. 3. In an example, the language generation model generates the set of first interpretations based on the second prompt as described with reference to FIG. 3.

FIG. 12 shows an example of a method 1200 for retrieving a set of text passages according to aspects of the present disclosure.

At operation 1205, the system retrieves a set of candidate text passages based on the query. In some cases, the operations of this step refer to, or is performed by, a retrieval component as described with reference to FIGS. 6 and 7. In an example, the retrieval component retrieves the set of candidate text passages as described with reference to FIG. 6.

At operation 1210, the system identifies a set of relevance scores based on the set of candidate text passages and the set of first interpretations. In some cases, the operations of this step refer to, or is performed by, a retrieval component as described with reference to FIGS. 6 and 7. In an example, the retrieval component identifies the set of relevance scores as described with reference to FIG. 6.

At operation 1215, the system selects the set of text passages from the set of candidate text passages based on the set of relevance scores. In some cases, the operations of this step refer to, or is performed by, a retrieval component as described with reference to FIGS. 6 and 7. In an example, the retrieval component selects the set of text passages as described with reference to FIG. 6.

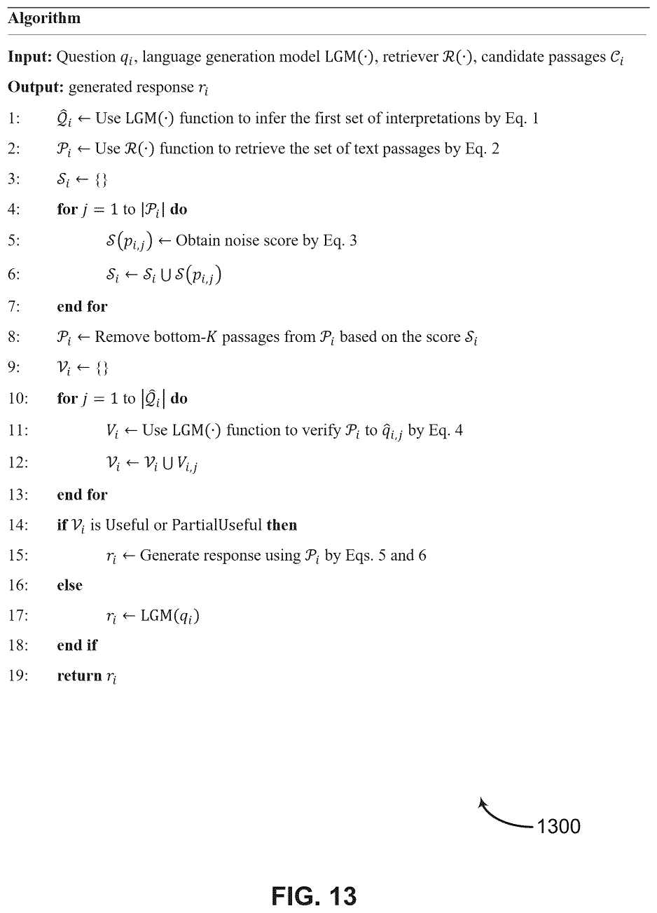

FIG. 13 shows an example of an algorithm 1300 for generating a response to a query according to aspects of the present disclosure. Referring to FIG. 13, algorithm 1300 describes a process for generating a response rᵢ as described with reference to FIGS. 10-12.

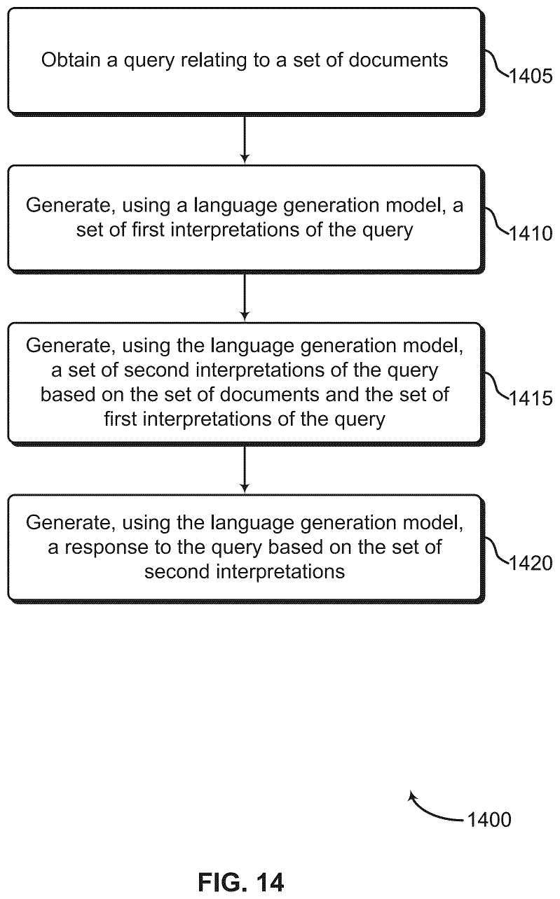

FIG. 14 shows an example of a method 1400 for generating a response based on interpretations of a query according to aspects of the present disclosure. Referring to FIG. 14, according to some aspects, a data processing system (such as the data processing system 100 described with reference to FIG. 1) performs method 1400 to generate a response to a query based on a set of first interpretations and a set of second interpretations.

At operation 1405, the system obtains a query relating to a set of documents. In some cases, the operations of this step refer to, or is performed by, a data processing apparatus as described with reference to FIGS. 1, 3, 6-8, 15, and 16. In an example, a user provides the query via a user interface of the data processing apparatus as described with reference to FIG. 1.

At operation 1410, the system generates, using a language generation model, a set of first interpretations of the query. In some cases, the operations of this step refer to, or is performed by, a language generation model as described with reference to FIGS. 1, 3, 7, 8, and 16. In an example, the language generation model generates the set of first interpretations as described with reference to FIG. 3.

At operation 1415, the system generates, using the language generation model, a set of second interpretations of the query based on the set of documents and the set of first interpretations of the query. In some cases, the operations of this step refer to, or is performed by, a language generation model as described with reference to FIGS. 1, 3, 7, 8, and 16. In an example, the language generation model generates the set of second interpretations as described with reference to FIG. 8.

At operation 1420, the system generates, using the language generation model, a response to the query based on the set of second interpretations. In some cases, the operations of this step refer to, or is performed by, a language generation model as described with reference to FIGS. 1, 3, 7, 8, and 16. In an example, the language generation model generates the response as described with reference to FIG. 8.

Accordingly, a method for data processing is described. One or more aspects of the method include obtaining a query relating to a set of documents; generating, using a language generation model, a plurality of first interpretations of the query; retrieving a plurality of text passages from the set of documents based on the plurality of first interpretations; and generating, using the language generation model, a response to the query based on the plurality of text passages. In some aspects, the set of documents are stored in a database and the plurality of text passages are retrieved from the database.

Some examples of the method further include retrieving a plurality of candidate text passages based on the query. Some examples further include selecting the plurality of text passages from the plurality of candidate text passages based on the plurality of first interpretations. Some examples of the method further include identifying a plurality of relevance scores based on the plurality of candidate text passages and the plurality of first interpretations, wherein the plurality of text passages are retrieved based on the plurality of relevance scores.

Some examples of the method further include generating, using the language generation model, an intermediate response based on the query, wherein the intermediate response describes an ambiguity of the query, and wherein the plurality of first interpretations is generated based on the intermediate response.

Some examples of the method further include generating a first prompt including the query and a plurality of candidate ambiguity types, wherein the intermediate response is generated based on the first prompt. Some examples of the method further include generating a second prompt including the query and an instruction to clarify the query based on the intermediate response, wherein the plurality of first interpretations are generated based on the second prompt. Some examples of the method further include determining whether the plurality of text passages encompasses the plurality of first interpretations, wherein the response is generated based on the determination.

Some examples of the method further include generating a plurality of second interpretations of the query based on the plurality of text passages, wherein the response is generated based on the plurality of second interpretations.

Furthermore, a method for data processing is described. One or more aspects of the method include obtaining a query relating to a set of documents; generating, using a language generation model, a plurality of first interpretations of the query; generating, using the language generation model, a plurality of second interpretations of the query based on the set of documents and the plurality of first interpretations of the query; and generating, using the language generation model, a response to the query based on the plurality of second interpretations.

Some examples of the method further include retrieving a plurality of text passages from the set of documents based on the plurality of first interpretations, wherein the plurality of second interpretations are generated based on the plurality of text passages. Some examples of the method further include retrieving a plurality of candidate text passages based on the query. Some examples further include selecting the plurality of text passages from the plurality of candidate text passages based on the plurality of first interpretations.

Some examples of the method further include identifying a plurality of relevance scores based on the plurality of candidate text passages and the plurality of first interpretations, wherein the plurality of text passages are retrieved based on the plurality of relevance scores. Some examples of the method further include determining whether the plurality of text passages encompasses the plurality of first interpretations, wherein the response is generated based on the determination.

Some examples of the method further include generating, using the language generation model, an intermediate response based on the query, wherein the intermediate response describes an ambiguity of the query, and wherein the plurality of first interpretations is generated based on the intermediate response.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Data Processing Apparatus

FIG. 15 shows an example of a computing device 1500 according to aspects of the present disclosure. Computing device 1500 is an example of, or includes aspects of, the data processing apparatus described with reference to FIGS. 1, 3, 6-8, and 16. In one aspect, computing device 1500 includes processor(s) 1505, memory subsystem 1510, communication interface 1515, I/O interface 1520, user interface component(s) 1525, and channel 1530. In some embodiments, computing device 1500 includes one or more processors 1505 that can execute instructions stored in memory subsystem 1510.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

FIG. 16 shows an example of a data processing apparatus 1600 according to aspects of the present disclosure. Data processing apparatus 1600 is an example of, or includes aspects of, the corresponding element described with reference to FIGS. 1, 3, 6-8, and 14. In some embodiments, data processing apparatus 1600 includes processor unit 1605, memory unit 1610, language generation model 1615, I/O module 1620, and training component 1625. Training component 1625 updates parameters of the language generation model 1615 stored in memory unit 1610. In some examples, the training component 1625 is located outside the data processing apparatus 1600.

Processor unit 1605 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1605 is configured to operate a memory array using a memory controller. In other cases, a memory controller is integrated into processor unit 1605. In some cases, processor unit 1605 is configured to execute computer-readable instructions stored in memory unit 1610 to perform various functions. In some aspects, processor unit 1605 includes special purpose components for modem processing, baseband processing, digital signal processing, or transmission processing. According to some aspects, processor unit 1605 comprises one or more processors 1505 described with reference to FIG. 15.

Memory unit 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1605 to perform various functions described herein.

In some cases, memory unit 1610 includes a basic input/output system (BIOS) that controls basic hardware or software operations, such as an interaction with peripheral components or devices. In some cases, memory unit 1610 includes a memory controller that operates memory cells of memory unit 1610. For example, the memory controller can include a row decoder, column decoder, or both. In some cases, memory cells within memory unit 1610 store information in the form of a logical state. According to some aspects, memory unit 1610 is an example of the memory subsystem 1510 described with reference to FIG. 15.

According to some aspects, data processing apparatus 1600 uses one or more processors of processor unit 1605 to execute instructions stored in memory unit 1610 to perform functions described herein. For example, in some embodiments, the data processing apparatus 1600 performs operations comprising obtaining a query relating to a set of documents; generating, using a language generation model, a plurality of first interpretations of the query; retrieving a plurality of text passages from the set of documents based on the plurality of first interpretations; and generating, using the language generation model, a response to the query based on the plurality of text passages.

According to some aspects, the memory unit 1610 includes a language generation model 1615. Language generation model 1615 comprises machine learning parameters stored in memory unit 1610. Language generation model 1615 is an example of, or includes aspects of, the corresponding element described with reference to FIGS. 1, 3, 7, and 8.

In some embodiments, the language generation model 1615 is an artificial neural network (ANN), such as a transformer model as described with reference to FIG. 9. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the language generation model 1615 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

According to some aspects, training component 1625 trains the language generation model 1615. For example, parameters of the language generation model 1615 can be learned or estimated from training data and then used to make predictions or perform tasks based on learned patterns and relationships in the data. In some examples, the parameters are adjusted during the training process to minimize a loss function or maximize a performance. The goal of the training process is to find optimal values for the parameters that allow the language generation model 1615 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the language generation model 1615 can be used to make predictions on new, unseen data (i.e., during inference).

I/O module 1620 receives inputs from and transmits outputs of the data processing apparatus 1600 to other devices or users. For example, I/O module 1620 receives inputs for the language generation model 1615 and transmits outputs of the language generation model 1615. According to some aspects, I/O module 1620 is an example of the I/O interface 1520 described with reference to FIG. 15.

According to some aspects, training component 1625 comprises executable code (e.g., software) stored in memory unit 1610, firmware, one or more hardware circuits, or a combination thereof.

The description and drawings described herein represent example configurations and do not represent all the implementations within the scope of the claims. For example, the operations and steps may be rearranged, combined or otherwise modified. Also, in some embodiments, structures and devices are represented in the form of block diagrams to represent the relationship between components and avoid obscuring the described concepts. In some embodiments, similar components or features have the same name but have different reference numbers corresponding to different figures.

Some modifications to the disclosure may be readily apparent to those skilled in the art, and the principles defined herein are applicable to other variations without departing from the scope of the disclosure. Thus, the disclosure is not limited to the examples and designs described herein, but is to be accorded the broadest scope consistent with the principles and novel features disclosed herein.

According to some aspects, the functions described herein are implemented in hardware or software and are executed by a processor, firmware, or any combination thereof. In some embodiments, if implemented in software executed by a processor, the functions are stored in the form of instructions or code on a computer-readable medium.

Computer-readable media includes both non-transitory computer storage media and communication media including any medium that facilitates transfer of code or data. In some embodiments, a non-transitory storage medium is any available medium that is accessible by a computer. Also, in some embodiments, connecting components are properly termed computer-readable media. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” can be based on both condition A and condition B. In other words, the phrase “based on” shall be construed to mean “based at least in part on.” Also, the words “a” or “an” indicate “at least one.”

1. A method for data processing, comprising:
obtaining a query relating to a set of documents;
generating, using a language generation model, an intermediate response based on a first input to the language generation model, wherein the intermediate response describes an ambiguity of the query and the first input comprises the query;
generating, using the language generation model, a plurality of first interpretations of the query based on a second input to the language generation model, wherein the second input comprises the query and the intermediate response;
retrieving a plurality of text passages from the set of documents based on the plurality of first interpretations;
generating, using the language generation model, a response to the query based on a third input to the language generation model, wherein the third input comprises the plurality of text passages; and
displaying, using a hardware user interface, the response.

2. The method of claim 1, wherein:
the set of documents are stored in a database and the plurality of text passages are retrieved from the database.

3. The method of claim 1, wherein retrieving the plurality of text passages comprises:
retrieving a plurality of candidate text passages based on the query; and
selecting the plurality of text passages from the plurality of candidate text passages based on the plurality of first interpretations.

4. The method of claim 3, further comprising:
identifying a plurality of relevance scores based on the plurality of candidate text passages and the plurality of first interpretations, wherein the plurality of text passages are retrieved based on the plurality of relevance scores.

5. (canceled)

6. The method of claim 1, further comprising:
generating a first prompt including the query and a plurality of candidate ambiguity types, wherein the intermediate response is generated based on the first prompt.

7. The method of claim 6, further comprising:
generating a second prompt including the query and an instruction to clarify the query based on the intermediate response, wherein the plurality of first interpretations are generated based on the second prompt.

8. The method of claim 1, further comprising:
determining whether the plurality of text passages encompasses the plurality of first interpretations, wherein the response is generated based on the determination.

9. The method of claim 1, further comprising:
generating a plurality of second interpretations of the query based on the plurality of text passages, wherein the response is generated based on the plurality of second interpretations.

10. A non-transitory computer readable medium storing code for data processing, the code comprising instructions that, when executed by at least one processor, cause the at least one processor to perform operations comprising:
obtaining a query relating to a set of documents;
generating, using a language generation model, a plurality of first interpretations of the query based on a first input to the language generation model, wherein the first input comprises the query;
retrieving a plurality of text passages from the set of documents based on the plurality of first interpretations;
generating, using the language generation model, a plurality of second interpretations of the query based on a second input to the language generation model, wherein the second input comprises the query and the plurality of text passages;
generating, using the language generation model, a response to the query based on a third input to the language generation model, wherein the third input comprises the plurality of second interpretations; and
displaying, using a hardware user interface, the response.

11. The non-transitory computer readable medium of claim 10, wherein:
the plurality of second interpretations are generated based on the plurality of text passages.

12. The non-transitory computer readable medium of claim 11, wherein retrieving the plurality of text passages comprises:
retrieving a plurality of candidate text passages based on the query; and
selecting the plurality of text passages from the plurality of candidate text passages based on the plurality of first interpretations.

13. The non-transitory computer readable medium of claim 12, the code further comprising instructions that, when executed by the at least one processor, cause the at least one processor to perform operations comprising:
identifying a plurality of relevance scores based on the plurality of candidate text passages and the plurality of first interpretations, wherein the plurality of text passages are retrieved based on the plurality of relevance scores.

14. The non-transitory computer readable medium of claim 11, the code further comprising instructions that, when executed by the at least one processor, cause the at least one processor to perform operations comprising:
determining whether the plurality of text passages encompasses the plurality of first interpretations, wherein the response is generated based on the determination.

15. The non-transitory computer readable medium of claim 10, wherein generating the plurality of first interpretations comprises:
generating, using the language generation model, an intermediate response based on the query, wherein the intermediate response describes an ambiguity of the query, and wherein the plurality of first interpretations is generated based on the intermediate response.

16. A system comprising:
a memory component; and
a processing device coupled to the memory component, the processing device configured to perform operations comprising:
obtaining a query relating to a set of documents;
generating, using a language generation model, an intermediate response based on a first input to the language generation model, wherein the intermediate response describes an ambiguity of the query and the first input comprises the query;
generating, using a language generation model, a plurality of first interpretations of the query based on a second input to the language generation model, wherein the second input comprises the query and the intermediate response;
retrieving a plurality of text passages from the set of documents based on the plurality of first interpretations;
generating, using the language generation model, a response to the query based on a third input to the language generation model, wherein the third input comprises the plurality of text passages; and
displaying, using a hardware user interface, the response.

17. The system of claim 16, wherein:
the language generation model comprises a transformer model.

18. The system of claim 16, further comprising:
a database for storing the set of documents.

19. The system of claim 16, further comprising:
a retriever model configured to retrieve the plurality of text passages.

20. The system of claim 16, further comprising:
an encoder configured to encode the plurality of text passages and the plurality of first interpretations.
